(19) United States
(12) Patent Application Publication
(10) Pub. No.: US 2016/0344002 A1
(43) Pub. Date: Nov. 24, 2016

(54) BATTERY BAYS AND SYSTEMS CONFIGURED FOR DIFFERENT BATTERY TYPES

(71) Applicants: Connor J. Duncan, San Francisco, CA (US); Daniel S. Fuhrman, Ketchum, ID (US); John M. Prosser, Mays Hill (AU); Eric Andrew Dobbie, Ketchum, ID (US)

(72) Inventors: Connor J. Duncan, San Francisco, CA (US); Daniel S. Fuhrman, Ketchum, ID (US); John M. Prosser, Mays Hill (AU); Eric Andrew Dobbie, Ketchum, ID (US)

(73) Assignee: MOHOC, Inc., San Francisco, CA (US)

(21) Appl. No.: 15/217,403

(22) Filed: Jul. 22, 2016

Related U.S. Application Data
(63) Continuation of application No. 15/157,693, filed on May 18, 2016.
(60) Provisional application No. 62/163,705, filed on May 19, 2015.

(51) Int. Cl. H01M 2/10

(52) U.S. Cl. CPC H01M 2/1027; H01M 2/1072

(57) ABSTRACT

Battery holding and utilization systems wherein multiple, different disposable power sources, which can be rechargeable if desired, can be alternately held and used in a single battery bay.

### CROSS-REFERENCE TO RELATED APPLICATIONS

The present application claims the benefit of copending U.S. Provisional Patent Application Ser. No. 62/163,705, filed May 19, 2015, which application is incorporated herein by reference in its entirety.

### BACKGROUND

There has gone unmet a need for improved devices, systems and methods that can provide on-board, multiple-power-source functionality using different battery types having different shapes, different electrical connection configurations and different discharge characteristics, for example one battery type that is rechargeable and a second battery type that is disposable where the different battery types can be used in a single battery bay. Such configurations can be particularly advantageous for situations where power sources are uncertain such as for low profile camera housings used in military and/or first-responder environments.

The present devices, systems and methods, etc., provide one or more of these and/or other advantages.

### SUMMARY

In one aspect, the present systems, devices and methods, etc., provide battery holding systems wherein multiple, different disposable power sources can be alternately held and used in a single battery bay. Such different power sources may be rechargeable (in or outside the battery bay), have different energy levels, different discharge characteristics, be removable, etc.

The present systems, devices and methods, etc., provide battery bays configured to removably hold and use a plurality of different battery types each having different shapes, different electrical connection configurations and different discharge characteristics, wherein the battery bay contains a first set of electrical contacts located at a first location in the battery bay and configured to operably connect to and conduct electricity with a first battery type and a second set of electrical contacts located at a second location in the battery bay and configured to conduct electricity with a second battery type. The battery bay can be operably connected to battery-type recognition elements configured to identify and utilize power from the plurality of different battery types for selected electronic devices operably connected to the battery bay.

In some embodiments, the battery bay can be configured to hold at least one cylindrical battery as the first battery type and at least one non-cylindrical battery as the second battery type. The non-cylindrical battery can be box shaped. The battery bay can be configured such that on a first axis the battery bay comprises opposed electrical contacts corresponding to opposed electrical contacts of the first battery type and on a second axis the battery bay can be contacts for the second battery type. The first axis can be at 90° from the second axis. The battery bay can be configured to hold at least two cylindrical batteries as the first battery type and at least one non-cylindrical battery as the second battery type. The battery bay can also support a third or more battery types, which can for example be on a third axis, for example at 90° from the first and second axis (e.g., a Z-axis where the first and second axes are the X and Y axes). In other words, the battery bay can be configured to support as many different battery types, in as many different orientations and using as many different electrical contacts, as desired.

In other embodiments, the battery bay can be configured to hold at least one non-rechargeable battery as the first battery type and at least one rechargeable battery as the second battery type, which can be a rechargeable Li-ion battery. The battery bay can be configured for military/law enforcement-level use and/or for use within a low profile camera housing.

Further embodiments herein include battery bay systems comprising a) a battery bay as discussed herein and b) at least one battery type configured for use within the battery bay. The battery bay system can also include at least a second different battery type as discussed herein. At least one of first and second battery types can be a shape-variable battery. The battery bay and the shape-variable battery can be cooperatively configured such that the shape-variable battery substantially fills available space within the battery bay.

The system can further include computer implemented programming configured to identify and utilize power availability and power usage from the different battery types for a selected electronic device operably connected to the battery bay. In some embodiments, the selected electronic device is contained within a single housing that also contains the battery bay. The computer implemented programming can be operably connected to recognition elements configured to identify and utilize power from the plurality of different battery types. The selected electronic device can be a low profile camera housing containing the battery bay, such as a low profile concavely curved camera housing.

Further embodiments herein include methods comprising manufacturing a battery bay or battery bay system as discussed herein, as well as methods comprising using a battery bay or battery bay system as discussed herein.

These and other aspects, features and embodiments are set forth within this application, including the following Detailed Description and attached drawings. In addition, various references are set forth herein, including in the Cross-Reference To Related Applications, that discuss certain systems, apparatus, methods and other information; all such references are incorporated herein by reference in their entirety and for all their teachings and disclosures, regardless of where the references may appear in this application.

### BRIEF DESCRIPTION OF THE DRAWINGS

FIG. 1 depicts a top perspective view of a battery bay system as discussed herein with a Li-ion battery in the bay in a low profile concavely curved camera unit containing the battery and battery bay.

FIG. 2 depicts a top perspective view of a battery bay system as discussed herein comprising an external power system for a secondary device such as a computer with a Li-ion battery in the hay and a power cord extending from the power system.

FIG. 3 depicts a top perspective view of a battery bay system as discussed herein with a Li-ion battery partially removed from or inserted into the battery bay.

FIG. 4 depicts a top plan view of a battery bay system as discussed herein with a Li-ion battery fully removed from the battery bay and cylindrical batteries with opposed contacts ready for insertion into the battery bay.

### DETAILED DESCRIPTION

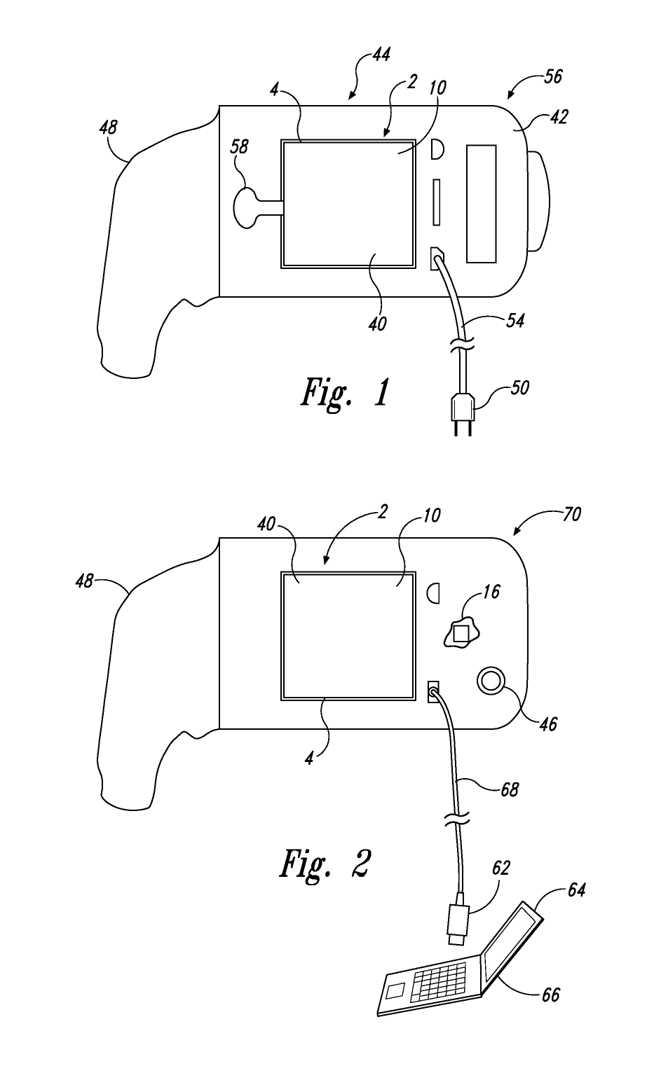

One example of such a battery bay and corresponding battery system is shown in FIGS. 1-5, which show such a battery system in a rugged, low profile camera housing having a tactile-based user interface and as a power source for, and operatively connectable to, a secondary device such as a computer or mobile phone.

FIG. 1 depicts a top perspective view of a battery bay system 2 as discussed herein with a first battery type 10, here a non-cylindrical battery 20 in the form of a rechargeable Li-ion battery 40 in the battery bay 4. Any type of battery desired may be used for each of the various batteries that may be accommodated in a single battery bay 4, e.g. rechargeable or non-rechargeable, Li-ion, nickel-metal hydride (NiMH), nickel cadmium (NiCd), etc. The battery bay 4 is configured to removably hold and use a plurality of different battery types each having different shapes, different electrical connection configurations and different discharge characteristics. In this embodiment, a power cord 54 having a power plug 50 is operably, releasably connected to a camera unit 56 containing the battery bay 4 within a camera housing 60 (here, a low profile camera housing 44) and covered by a battery bay cover 48, which is in the open position as shown so that the battery bay system 2, first battery type 10 and battery bay 4 can be more easily seen.

Power cord 54 can be used, for example, either to charge rechargeable Li-ion battery 40 and/or to provide an alternate power source for camera unit 56 to reduce drain on rechargeable Li-ion battery 40 when the power cord 54 is plugged in. Bay-attached battery release pull-tab 58 extends underneath rechargeable Li-ion battery 40 such that pulling on bay-attached battery release pull-tab 58 easily dislodges the battery from the battery bay 4. Notch 74 provides a further approach to removing the battery 40.

FIG. 2 depicts a top perspective view of a battery bay system 2 wherein the system 2 serves as an external power source 70 for a secondary (external) device 66 such as a computer 64 (not drawn to scale). Battery bay system 2 comprises an external power delivery system 62 for the secondary device 66 and as depicted contains with a Li-ion battery 40 in the battery bay 4 and a delivery power cord 68 extending from the power system; power could also be transferred wirelessly. Such external power sources 70 can be particularly useful, for example, as reserve power sources in the event of general power failure or need for use or the external device.

FIG. 2 also schematically depicts battery-type recognition elements 16, which identify and utilize power from the plurality of different battery types that can be disposed in and utilized in the battery bay 4, for selected electronic devices operably connected to the battery bay 4. Such battery-type recognition elements 16 can include electrical leads as shown in other figures herein, and the battery bay system 2 and/or battery-type recognition elements 16 can further include computer implemented programming configured to identify and utilize power availability and power usage from the different battery types for a selected electronic device operably connected to the battery bay 4. In some embodiments, such as in FIGS. 1, 3 and 4, the selected electronic device is contained within a single housing that also contains the battery bay 4, such as camera housing 60, or, as in FIG. 2, the selected electronic device located away from the housing that contains the battery bay 4, such as the computer 64 shown in FIG. 2. The computer implemented programming can be software configured to identify and utilize, and preferably to maximize, power availability and power usage from the different battery types for the target electronics. The recognition elements can also comprise computer-readable media such as memory structures that contain such computer implemented programming.

The battery bay system 2 can also comprise one or more control elements permitting a user manually control one or more aspects or features of the battery bay system 2, for example via a control knob 46.

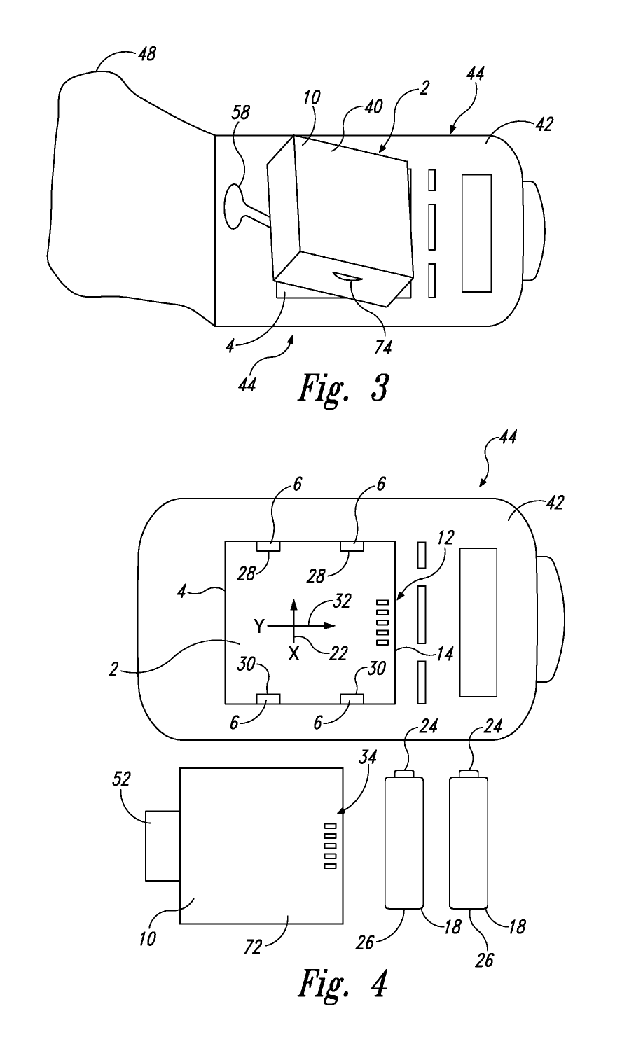

FIG. 3 depicts a top perspective view of a battery bay system 2 as discussed herein with the Li-ion battery 40 partially removed from or inserted into the battery bay 4.

FIG. 4 depicts a top plan view of a battery bay system 2 with cylindrical batteries 18 with opposed electrical contacts 24, 26 as a first battery type and a variable-shape battery 72 as a second battery type ready for insertion into the battery bay 4. Variable-shape battery 72 comprises battery-attached battery release pull-tab 52, which can be useful if the battery bay 4 does not contain a battery release element. Battery bay 4 comprises opposed battery bay electrical contacts 28, 30 forming a first set of electrical contacts 6 that correspond to opposed battery electrical contacts 24, 26 of the first battery type and are in first location in the battery bay 8. A second set of electrical contacts 12, which can be useful for recharging a battery (as can other electrical contacts) are located in a second location 14 in the battery bay 4 and correspond to second-type battery contacts 34. In this FIG. 4, opposed battery bay electrical contacts 28, 30 are disposed along a first axis 22 of the battery bay 4 while the second set of electrical contacts 12 are disposed along a second axis 32 of the battery bay 4, here at 90°. Additional set(s) of contacts, different shapes of battery bay (which shape may not include a depression as in the figures), etc., can be provided as desired.

Turning to a further general discussion of the present systems, devices and methods, etc., herein, such provide battery bays configured to removably hold and use a plurality of differently shaped batteries each with different electrical contact configurations within a single bay. The battery bay is a section or compartment that is configured to hold and use two different types of insertable and removable batteries. “Different battery types” as used herein means batteries that have different shapes, different electrical connection configurations and different discharge characteristics. For example, “Different battery types” means on the one hand one, two or three cylindrical batteries such as AA, AAA (which AA and AAA batteries do not have different electrical connection configurations) or CR123A batteries, and then on the other hand a box-shaped rechargeable Li-ion battery. The bay can be within the electronic device or operably connected to it, for example via an HDMI cord or via wireless energy transfer technology.

The shape of the battery bay can advantageously be rectangular such as or square or oblong but can also be other shapes as desired. If desired, the square or oblong shape can be configured to mimic the size and shape of the largest of the 2, 3 or more different types of batteries that can be inserted in and used in the battery bay. The different battery types have different power discharge and/or delivery characteristics including for example one or more of a) different electrical contact configurations (for example, cylindrical batteries such as D batteries or CR123A batteries typically comprise positive and negative contacts at opposed ends of the batteries whereas Li-ion batteries can be configured in box-shapes (i.e., substantially rectangular solids or other solid-type shapes) with a row of electrical contacts disposed side-by-side; b) different discharge characteristics over time wherein the amperage or voltage discharge varies differently as the battery proceeds from fully charged to fully discharged; and c) different volt, amp or watt strengths or capabilities.

In some embodiments, such as in the rugged, low profile camera system shown in the Figures, the battery system further comprises recognition elements within the battery system that can identify and utilize power from the different battery types for the selected electronic devices operably connected to the battery bay. Such recognition elements can comprise computer implemented programming such as software configured to identify and utilize, and preferably to maximize, power availability and power usage from the different battery types for the target electronics. The recognition elements can also comprise computer-readable media such as memory structures that contain such computer implemented programming.

The battery bay is configured to releasably hold each of the different battery types. In some embodiments, for example where the battery bay system is configured to hold cylindrical batteries on the one hand and non-cylindrical, shape-variable batteries such as box-style Li-ion batteries, the system is cooperatively configured such that in one direction (axis) the battery bay comprises opposed electrical contacts corresponding to the opposed ends/electrical contacts of the cylindrical battery(ies) and on another axis, for example at 90° from the first axis, the battery bay comprises contacts for the corresponding electrical contacts of the shape-variable battery. Further, if desired, the shape of the battery bay can be configured such that the shape-variable battery substantially fills the available space within the battery bay. Examples of such embodiments are shown in FIGS. 1-5 herein.

In one embodiment, the battery bay systems and corresponding batteries are ruggedly configured for use with military personnel or first-responders. As used herein, “military/law enforcement-level” means law enforcement officers, firefighters, soldiers, sailors, and the like, i.e., personnel who are likely to encounter heavy blunt force impacts such as vehicle crashes, bats, truncheons, thrown rocks and ballistic impacts such as .22 caliber and 9-millimeter and .44 magnum bullets as well as fragmentations from anti-personnel devices such as grenades and improvised explosive devices (IEDs). Thus, a military/law enforcement-level protection system herein typically meets or exceeds the 2010 National Institute of Justice (NIJ) Level IIIA helmet standards for the helmets herein, 2010 NIJ IIIA standards for body armor, and the face protection element and ballistic armor meets or exceeds or MIL-DTL-43511D and/or the 2010 NIJ Level I, Level IIA, or Level II body armor standards, as desired. Helmets suitable for use with the camera housings discussed herein are military-level helmets such as the Combat Vehicle Crewman (CVC) helmet and an Army Combat Helmet (ACH), as well as the Modular Integrated Communications Helmet (MICH), Personnel Armor System for Ground Troops (PASGT), Lightweight Helmet (LWH), Future Assault Shell Technology (FAST) Helmet, Battleskin, Exfil, etc.

In certain embodiments, the battery bay is located within a low profile concavely curved camera housing. Such units typically comprise the following: a) a concave base surface structured to match an outer curvature of a convexly curved base substrate—“concave” as used herein means that the curvature of the base bows inwardly toward the center of the camera housing while “convex” means the opposite curvature; b) a single-motion releasable attachment element such as hook-and-loop fabric, magnets, adhesive or snaps that attaches the base surface to the helmet in a single motion by the user without negatively affecting the integrity of the helmet, and in some embodiments without any additional hardware specifically configured for such attachment of the housing to the helmet; c) is smooth such that all upper surfaces (i.e., all surfaces above the convex base surface) of the housing are without projections or elements that pose a snag hazard while the attachment between the convex base surface of the housing and the convexly curved base substrate contains no gaps or protrusions on which a cord, branch, etc., might catch; and/or d) a very simple, tactile user interface and user experience (UI/UX) comprising only controls that can be operated by a single hand without visual interaction by the user and while wearing gloves. As noted above, exemplary camera housings and user interfaces are discussed in U.S. Provisional Patent Application No. 62/000,151 entitled “LOW PROFILE CAMERA HOUSINGS HAVING CONCAVELY CURVED BASE SURFACES AND RELATED SYSTEMS AND METHODS”, filed May 19, 2014, attorney Reference No.: 3094-001-02 as well as in U.S. patent application Ser. No. 14/716,312 entitled “LOW PROFILE CAMERA HOUSINGS HAVING CONCAVELY CURVED BASE SURFACES AND RELATED SYSTEMS AND METHODS”, filed May 19, 2015, attorney Reference No.: 3094-001-03 and U.S. patent application Ser. No. 14/716,379 entitled “CAMERA HOUSINGS HAVING TACTILE CAMERA USER INTERFACES FOR IMAGING FUNCTIONS FOR DIGITAL PHOTO-VIDEO CAMERAS”, filed May 19, 2015, attorney Reference No.: 3094-006-03, all of which are incorporated herein in their entirety. Nevertheless, as noted herein and shown in FIG. 2, the aspects and embodiments discussed in this application apply also to other electronic devices such as desk top computers, or portable electronic devices such as laptop computers, tablets, SLR cameras, mobile phones, etc., unless the application or claims state that a particular aspect or embodiment applies only to rugged, low profile camera housings and/or to electronic systems having only tactile user interfaces.

All terms used herein are used in accordance with their ordinary meanings unless the context or definition clearly indicates otherwise. Also unless expressly indicated otherwise, in the specification the use of “or” includes “and” and vice-versa. Non-limiting terms are not to be construed as limiting unless expressly stated, or the context clearly indicates, otherwise (for example, “including,” “having,” and “comprising” typically indicate “including without limitation”). Singular forms, including in the claims, such as “a,” “an,” and “the” include the plural reference unless expressly stated, or the context clearly indicates, otherwise.

The scope of the present devices, systems and methods, etc., includes both means plus function and step plus function concepts. However, the claims are not to be interpreted as indicating a “means plus function” relationship unless the word “means” is specifically recited in a claim, and are to be interpreted as indicating a “means plus function” relationship where the word “means” is specifically recited in a claim. Similarly, the claims are not to be interpreted as indicating a “step plus function” relationship unless the word “step” is specifically recited in a claim, and are to be interpreted as indicating a “step plus function” relationship where the word “step” is specifically recited in a claim.

From the foregoing, it will be appreciated that, although specific embodiments have been discussed herein for purposes of illustration, various modifications may be made without deviating from the spirit and scope of the discussion herein. Accordingly, the systems and methods, etc., include such modifications as well as all permutations and combinations of the subject matter set forth herein and are not limited except as by the appended claims or other claim having adequate support in the discussion and figures herein.

1. A battery bay configured to removably hold and use a plurality of different battery types each having different shapes, different electrical connection configurations and different discharge characteristics, wherein the battery bay comprises a first set of electrical contacts located at a first location in the battery bay and configured to conduct electricity with a first battery type and a second set of electrical contacts located at a second location in the battery bay and configured to conduct electricity with a second battery type.

2. The battery bay of claim 1 wherein the battery bay is operably connected to recognition elements configured to identify and utilize power from the plurality of different battery types for at least one selected electronic device operably connected to the battery bay.

3. The battery bay of claim 1 wherein the battery bay is configured to hold at least one cylindrical battery as the first battery type and at least one non-cylindrical battery as the second battery type.

4. The battery bay of claim 3 wherein the non-cylindrical battery is box shaped.

5. The battery bay of claim 1 wherein the battery bay is configured such that on a first axis the battery bay comprises opposed electrical contacts corresponding to opposed electrical contacts of the first battery type and on a second axis the battery bay comprises contacts for the second battery type.

6. The battery bay of claim 5 wherein the first axis is at 90° from the second axis.

7. The battery bay of claim 5 wherein the first battery type is a cylindrical battery and the second battery type is a box-shaped battery.

8. The battery bay of claim 1 wherein the battery bay is configured to hold at least two cylindrical batteries as the first battery type and at least one non-cylindrical battery as the second battery type.

9. The battery bay of claim 1 wherein the battery bay is configured to hold at least one non-rechargeable battery as the first battery type and at least one rechargeable battery as the second battery type.

10. The battery bay of claim 1 wherein the battery bay is configured to hold at least one rechargeable Li-ion battery.

11. The battery bay of claim 1 wherein the battery bay is configured for military/law enforcement-level use.

12. The battery bay of claim 1 wherein the battery bay is configured for use within a low profile camera housing.

13. A battery bay system comprising a) a battery bay configured to removably hold and use a plurality of different battery types each having different shapes, different electrical connection configurations and different discharge characteristics, wherein the battery bay comprises a first set of electrical contacts located at a first location in the battery bay and configured to conduct electricity with a first battery type and a second set of electrical contacts located at a second location in the battery bay and configured to conduct electricity with a second battery type and b) at least one battery type configured for use within the battery bay.

14. The battery bay system of claim 13 battery bay system comprises at least a second different battery type configured for use within the battery bay.

15. The battery bay system of claim 13 wherein at least one of first and second battery types is a shape-variable battery.

16. The battery bay system of claim 15 wherein the battery bay and the shape-variable battery are cooperatively configured such that the shape-variable battery substantially fills available space within the battery bay.

17. The battery bay system of claim 13 wherein the system further includes computer implemented programming configured to identify and utilize power availability and power usage from the different battery types for a selected electronic device operably connected to the battery bay.

18. The battery bay system of claim 17 wherein the computer implemented programming is operably connected to recognition elements configured to identify and utilize power from the plurality of different battery types.

19. The battery bay system of claim 18 wherein the selected electronic device is a low profile camera housing containing the battery bay.

20. The battery bay system of claim 19 wherein the low profile camera housing is a low profile concavely curved camera housing.

21. A method comprising manufacturing a battery bay wherein the battery bay is configured to removably hold and use a plurality of different battery types each having different shapes, different electrical connection configurations and different discharge characteristics, wherein the battery bay comprises a first set of electrical contacts located at a first location in the battery bay and configured to conduct electricity with a first battery type and a second set of electrical contacts located at a second location in the battery hay and configured to conduct electricity with a second battery type.

22. (canceled)

23. A method comprising using a battery bay wherein the battery bay is configured to removably hold and use a plurality of different battery types each having different shapes, different electrical connection configurations and different discharge characteristics, wherein the battery bay comprises a first set of electrical contacts located at a first location in the battery bay and configured to conduct electricity with a first battery type and a second set of electrical contacts located at a second location in the battery bay and configured to conduct electricity with a second battery type,
wherein the method comprises inserting a first battery type having a first shape, electrical connection configuration and discharge characteristic into the battery bay to contact the first set of electrical contacts and inserting a second battery type having a second shape, electrical connection configuration and discharge characteristic into the battery bay to contact the second set of electrical contacts.

24. (canceled)

25. The method of claim 23 wherein method further comprises using recognition elements to identify and utilize power from the plurality of different battery types for at least one selected electronic device operably connected to the battery bay.

26. The method of claim 23 wherein the first battery type is cylindrical and the second battery type is non-cylindrical.

27. The method of claim 26 wherein the non-cylindrical battery is box shaped.

28. The method of claim 23 wherein the battery bay is configured such that on a first axis battery bay comprises opposed electrical contacts corresponding to opposed electrical contacts of the first battery type and on a second axis the battery bay comprises contacts for the second battery type.

29. The method of claim 28 wherein the first axis is at 90° from the second axis.

30. The method of claim 23 wherein the battery bay is configured to hold at least one non-rechargeable battery as the first battery type and at least one rechargeable battery as the second battery type.

31. The method of claim 23 wherein the battery bay is configured to hold at least one rechargeable Li-ion battery.

32. The method of claim 23 wherein the battery bay is configured for use within a low profile camera housing.
